(19) United States
(12) Patent Application Publication
(10) Pub. No.: US 2016/0048198 A1
(43) Pub. Date: Feb. 18, 2016

(54) STATE CHANGING DEVICE

(71) Applicant: NVIDIA Corporation, Santa Clara, CA (US)

(72) Inventors: Darshan Uppinkere Bhadraiah, Pune (IN); Jithin Thomas, Pune (IN)

(21) Appl. No.: 14/458,767

(22) Filed: Aug. 13, 2014

(51) Int. Cl. G06F 1/32; H04M 1/73; G06K 9/78

(52) U.S. Cl. CPC G06F 1/3296; G06K 9/78; H04M 1/73; G06F 1/3206

(57) ABSTRACT

There is provided a state changing device. For example, in some examples, there is a portable computing device including a first digital image sensor facing out from a first side of the portable computing device, a second digital image sensor facing out from a second side of the portable computing device, and state change circuitry coupled to the first digital image sensor and the second digital image sensor, the state change detection circuitry designed to receive a first image from the first digital image sensor, receive a second image from the second digital image sensor, and change a state of the portable computing device or an application running on it if the first image is a blank image and the second image is not a blank image.

### BACKGROUND

This disclosure relates generally to electronics and more particularly to the control of mobile computing devices. Over the past few years, mobile computing devices, such as tablets and mobile phones, have become an increasingly integral part of many people's personal and profession lives. At the same time, these devices have increased in size, complexity, and power usage. Many mobile computing device users complain that their devices do not have sufficient battery life to provide a full day's worth of use. Many mobile computing device users also complain that the power saving features are difficult to employ or require manual dexterity that is difficult or cumbersome with many modern computing devices.

### SUMMARY

There is provided a portable computing device including a first digital image sensor facing out from a first side of the portable computing device, a second digital image sensor facing out from a second side of the portable computing device, and state change detection circuitry coupled to the first digital image sensor and the second digital image sensor, the state change detection circuitry designed to receive a first image from the first digital image sensor; receive a second image from the second digital image sensor and change a state of the portable computing device if the first image is a blank image and the second image is not a blank image. The state change circuitry may be designed to place the portable computing device in a sleep mode. The state change circuitry may be designed to pause an application running on the portable computing device. The state change circuitry may be designed to poll the first digital image sensor. The state change circuitry may be designed to poll the first image sensor based on a signal generated from an ambient light sensor. The first side of the portable computing device may be a front surface of the portable computing device. The first side of the portable computing device and the second side of the portable computing device may be generally parallel to each other. There is also provided a portable computing device including an operating system that allows for selection of the state change from one or more state change options. The portable computer device me be a mobile telephone.

There is also provided a method including receiving an input from a first image sensor, determining if the input from the first image sensor is blank, receiving an input from a second image sensor, determining if the input from the second image sensor is blank, and changing a state of a mobile computing device if the first input is blank and the second input is not blank. Changing the state of the mobile computing device may include placing a mobile phone into a sleep state. Receiving the input from the second image sensor may include receiving an image from a camera facing a back surface of the mobile computing device and polling the first image sensor if a polling condition is satisfied. The first image sensor may be polled based on an input from an ambient light sensor. The polling condition may be a signal from a gyroscope. Receiving the input from the first image sensor may include receiving an image from a CMOS sensor.

There is also provided a non-transitory computer readable medium storing instructions that, when executed by the processing unit, causes the processing unit to perform operations including receiving an input from a first image sensor, determining if the input from the first image sensor is blank, receiving an input from a second image sensor, determining if the input from the second image sensor is blank, and changing a state of a mobile computing device if the first input is blank and the second input is not blank. The non-transitory computer readable medium may include instructions that, when executed by the processing unit, causes the processing unit to perform operations to poll the first image sensor if a polling condition occurs. The non-transitory computer readable medium may include instructions for placing the processing unit into a sleep mode. The non-transitory computer readable medium may include instructions for receiving an image from a digital camera facing the front surface of a mobile computing device.

### BRIEF DESCRIPTION OF THE DRAWINGS

FIG. 1 is a block diagram of an example mobile computing device in accordance with example implementations;

FIG. 2 is a flow chart of an example process for changing application state in accordance with example implementations;

FIG. 3 is a flow chart of an example mobile device display screen in accordance with example implementations; and

FIG. 4 is a flow chart of another example process for changing application state in accordance with example implementations.

### DETAILED DESCRIPTION

In some implementations described below, a mobile computing device may be designed to automatically change an application state when placed down by a user. For example, a mobile computing device may be configured to enter a lower power mode, turn off its screen, or pause/end a program application when placed down on a table by the user.

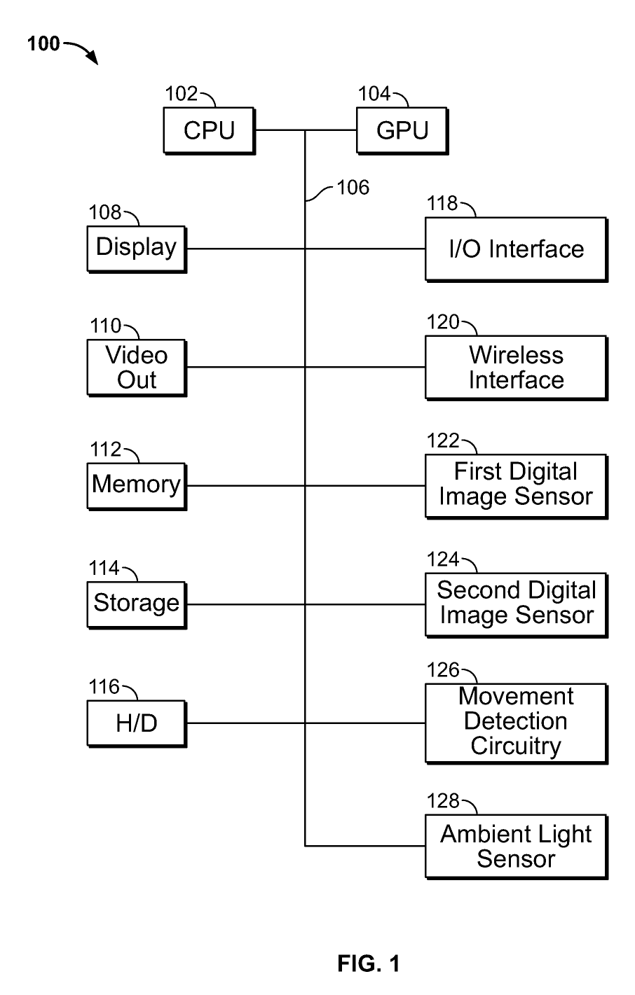

FIG. 1 depicts an example mobile computing device 100. In various example implementations, the mobile computing device 100 may be a tablet computing device, a smartphone, a phablet, a netbook, or a laptop computer. As shown, the device 100 may include at least one central processing unit (“CPU”) 102. In some examples, the device 100 also includes a graphical processing unit (“GPU”) 104. In some examples, the CPU 102 and the GPU 104 may be part of a single integrated circuit or part of a single integrated circuit package or module. In some implementations, the GPU 104 may include a plurality of shader modules and/or rasterization modules. Each of the foregoing modules may even be situated on a single semiconductor substrate. For example, the CPU 102 and GPU 104 may be part of an NVIDIA Tegra system on chip product.

The CPU 102 and GPU 104 may be connected to one or more communication buses 106 which interconnect the CPU 102 and/or GPU 104 with the various components of the device 100. The bus 106 may be connected to a display 108. In some implementation, the display 108 may be a touch screen LCD display, although any suitable type of mobile computing device display may be employed. The bus 106 may also be coupled to a video out port, such as an HDMI port.

The bus 106 may also be coupled to a memory 112. The memory 112 may be any suitable form of system memory, including, but not limited to, random access memory (“RAM”), dynamic RAM (“DRAM”) or static RAM (“SRAM”). The system 200 may also include storage 114. The storage 114 includes, for example, a hard disk drive and/or a removable storage system, including but not limited to solid state storage, a flash memory drive, a magnetic tape drive, and/or a memory card. The removable storage drive reads from and/or writes to a removable storage unit in a well-known manner.

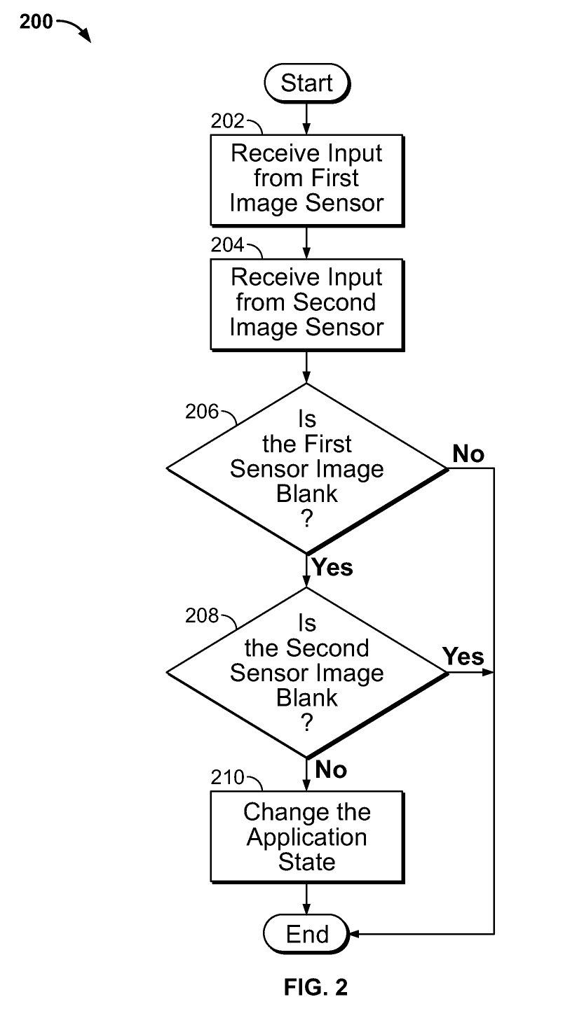

Computer programs, firmware, or computer control logic algorithms, may be stored in the memory 112 and/or the storage 114. Such computer programs, when executed, enable the CPU 102, GPU 104, and/or the device 100 to perform various functions. Memory 112, storage 120, and/or any other storage are possible examples of computer-readable media. In some implementations, the stored computer programs, firmware, or computer control logic algorithms may be configured such that when executed they perform the process flows described below in regard to FIG. 2, 4, or 5.

The bus 106 may be also coupled to a human interface device (“HID”) 116. In some implementations, the HID 116 is a keyboard that is either integrated into or connected to the device 100. In some implementations, the functions of the HID 116 may be performed by software via a touch-screen keyboard or other input mechanism displayed on the display 108. The bus 106 may further be coupled to input/output (“I/O”) interface 118. The I/O interface may comprise anyone of a number of suitable input/output standards, including but not limited to universal serial bus (“USB”) and IEEE 1394 (“Firewire”).

The bus 106 may further be coupled to a first digital image sensor 122 and/or a second digital image sensors 124. The image sensors 122 and 124 may be any type of suitable image sensor, including charge-coupled devices (“CCD”) devices, active pixel sensors, and CMOS or NMOS sensors. In some implementations, the digital image sensors 122 and 124 comprise digital cameras capable of taking both digital still images and digital video. In some implementations, the digital image sensors are controlled by the CPU 102 or GPU 104. In other implementations, the device 100 may include additional circuitry (not shown in FIG. 1) that controls one or both of the digital image sensors 122 and 124.

The bus 106 may further be coupled to a movement detection circuitry 126. In some implementations, the movement detection circuitry may be formed of any suitable form of micro-electro-mechanical-system (“MEMS”), including a microsensor, microactutor, or microstructure. In some implementation, the movement detection circuitry may be one or more mobile accelerometers and/or mobile gyroscopes, such as a 3-axis MEMS based accelerometer.

Additionally, in some implementations, the architecture and/or functionality of one or more components of FIG. 1 previous may be implemented on a system on chip or other integrated solution.

FIG. 2 is a flow chart of an example process 200 for changing application state in accordance with example implementations. In some implementations, the process 200 may be performed by the mobile computing device 100 of FIG. 1. However, in other examples, any suitable mobile device may implement the process 200.

The process 200 may begin with receiving an input from the first image sensor, as indicated by block 202 of FIG. 2. For example, the CPU 202 of device 100 may receive a digital image from the first digital image sensor 122. The process 200 may continue by receiving an input from a second image sensor (block 124), such as the image sensor 124. In various implementations, the blocks 202 and 204 may be performed at the same time, at overlapping times, or the block 204 may be performed prior to the block 202.

The process 200 may continue by determining if the input from the first sensor, which in some implementations may be an image, is blank. For example, the image received from the first digital image sensor 124 may be a solid color, such as brown or black indicating that the image sensor is receiving little or no light. If the image from the first sensor is not blank, the process 200 will end. However, if the image from the first sensor is blank, it could indicate that the mobile computing device has been placed face down on table or other flat surface and the process 200 will continue. For example, if first digital image sensor 122 is a front facing camera, placing it down on a table would be reflected by a blank image from the first digital image sensor 122.

If the input from the first sensor is blank, the process 200 may include determining if the input/image from the second sensor is blank, as shown in block 208. If the image received from the second sensor is blank, the process 200 will end as it likely indicates that the environment in which the mobile computing device is located is dark rather than indicating that the user has placed the mobile computing device down. Although the process 200 illustrates the image from the first image sensor being received prior to the image from the second image sensor, this is merely exemplary. In some implementations, the image from the second image sensor may be received and/or processed first or the two images may be received or process at overlapping times.

However, if the second sensor image is not blank, it confirms that the mobile computing device has been placed down and the process 200 is moved forward to block 210. At block 210, the process 200 will change the state of an application (process) executing on the mobile computing device, such as the mobile computing device 100. In various implementations, the change of application state may involve or include locking the mobile computing device, pausing a software application, such as an app, running on the mobile computing device, exiting a software application, pausing the playing of media, such as audio or video, forwarding calling to voicemail, stopping notifications or messaging, powering off the mobile computing device's display or other discrete hardware components, powering off the mobile computing device itself, and/or entering a sleep mode. It will be noted that the changes of application state set forth above are merely exemplary, and in various implementations, the change of application state may include anyone of a number of different changes to the hardware or software state or status.

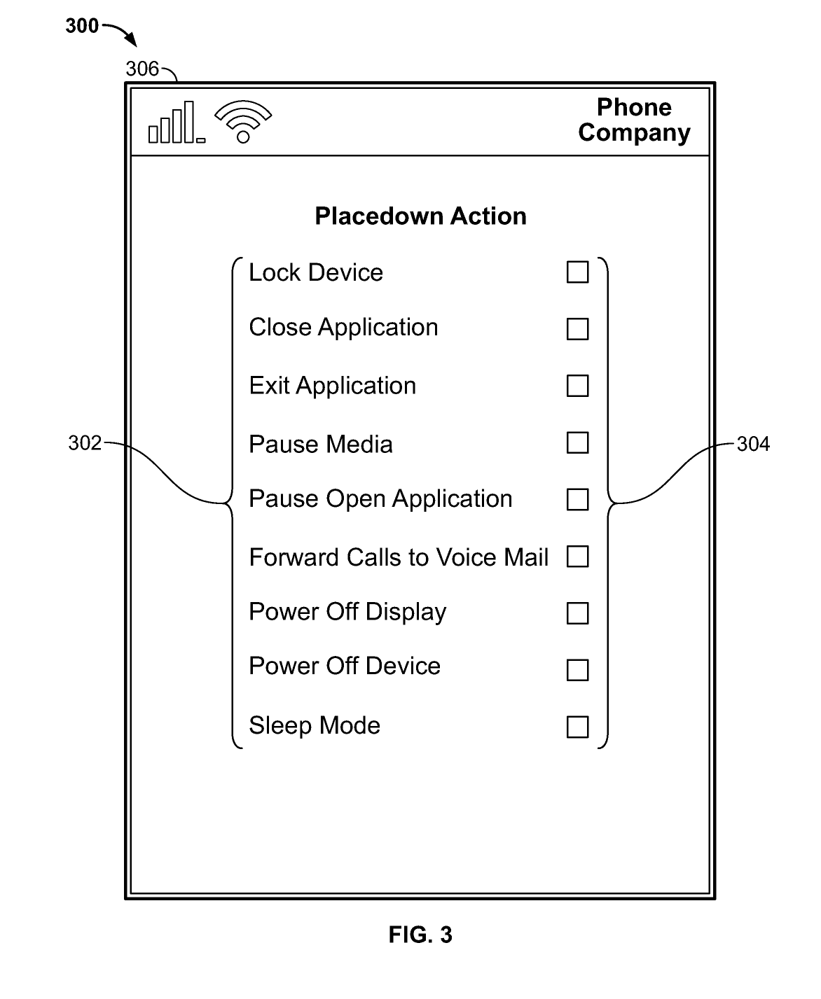

FIG. 3 illustrates an example mobile computing device configuration screen 300 in accordance with various implementations. The exemplary placedown action configuration screen 300 may be displayed on a mobile device screen, such as the display 108, during the setup or configuration stage. As shown in FIG. 3, the screen 300 displays one or more application state changes 302 that may be performed when a mobile computing device is placed down along with a mechanism 304 for selecting one or more of the changes to be performed when the mobile computer device is placed down. For example, a user may select one or more application states to change if the process 200 is performed and reaches block 210. Although the mechanism 304 is shown in FIG. 3 to include selectable check boxes, any suitable form of on-screen or off-screen selection may be employed. In addition, the screen 300 may include one or more information fields 306 to display signal strength, network status, and/or other operational features of the mobile computing device, such as the mobile computing device 100.

In some implementations, the mobile computing device 100 may be configured to periodically poll the first digital sensor 122 and/or the second digital sensor 124 for an image. For example, the CPU 102 may be configured to poll the camera once per second or once every few seconds. In other implementations, the CPU 102 or mobile computing device 100 may be configured to only poll the first digital image sensor 122 and/or the second digital image sensor after a particular polling condition is satisfied. Waiting until a polling condition is met before polling one or more cameras on the mobile computing device may be advantageous to reduce the power usage by the mobile device and/or reduce the processing load versus periodically polling the cameras.

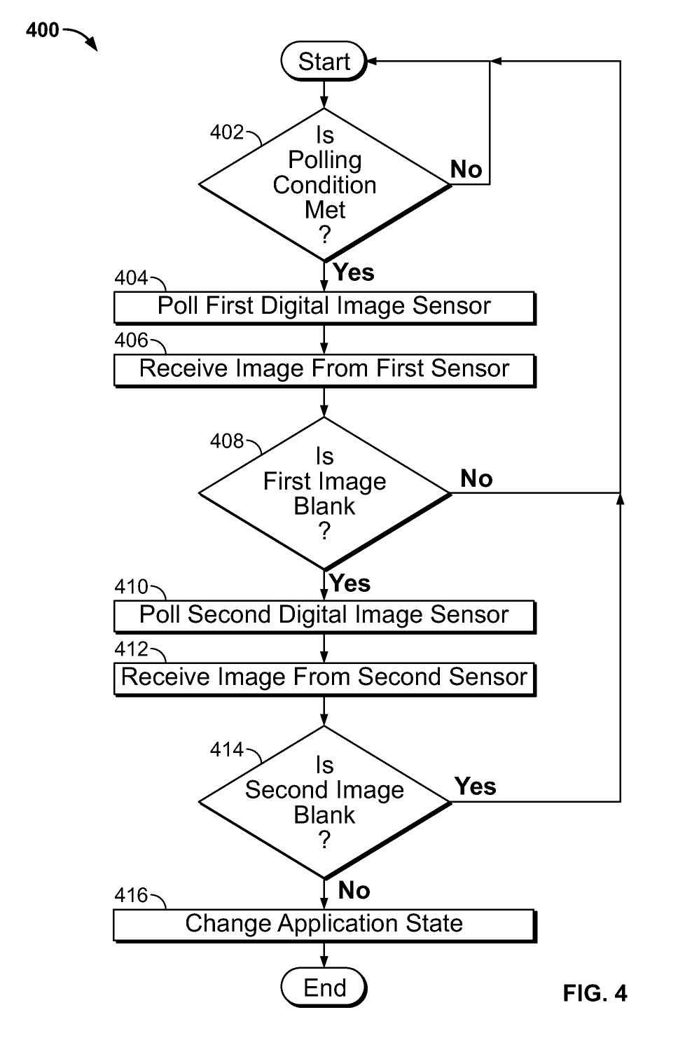

FIG. 4 is a flow chart of an example process 400 for changing application state in accordance with example implementations. As illustrated, the process 400 involves the use of polling condition. In particular, as shown in block 402, the process 400 begins by determining if the mobile computing device meets one or more polling conditions. For example, the mobile computing device may use the movement detection circuitry 126 to determine that the mobile computing device 100 has been placed on a flat surface, which could indicate that the mobile computing device has been placed down. In another example, the mobile computing device may use the ambient light sensor to indicate that the mobile computing device has been placed down. In yet another example, the mobile computing device may be configured to poll on a clock or schedule, such as once every minute.

If the polling condition is met, the mobile computing device may poll a first digital image sensor, as indicated by block 404. In some example, the polling may involve sending an instruction to the digital image sensor 122 with a request for an image. Next, the exemplary block 406 may include receiving an image from the first sensor, such as the first digital image sensor 122. As shown in block 408, the next step in the process 400 may include determining if the first image is a blank image, such as determining if the image is a single dark color. For example, the mobile computing device may determine the that image is blank if the image has a solid, largely uniform dark image, such as would be shown if the mobile computing device were placed down on a table with the first digital image sensor facing down. If the image is not blank, the process 400 will return to the start.

If the first image is blank, the process 400 may poll the second image sensor and receive an image from the second sensor, as shown in blocks 410 and 412, which are the same as blocks 404 and 406 described above except that a different image sensor is used. For example, polling the second digital image sensor may include polling the second digital image sensor 124. As shown in block 414, the process 400 may next include determining if the second image is blank using the same techniques described above with regard to block 408. If the second image is blank, the process 400 will return to the start, because two blank images likely indicates that the mobile computing device was not placed down but is in fact in an area devoid of or with little light.

If the second image is not blank, such as if it includes an image of a ceiling, the process 400 will change the application state, as indicated by block 416. In some examples, changing the application state may include changing the state of the one or more applications selected using the screen 300. For example, the process 400 may include placing the mobile computing device 100 into a sleep state or locking the mobile computing device 100.

The architecture and/or functionality of the various previous figures may be implemented in the context of a computing device, a circuit board system, a game console system dedicated for entertainment purposes, an application-specific system, a mobile system, and/or any other desired system, for that matter. Just by way of example, the mobile computing device may be a lap-top computer, hand-held computer, mobile phone, personal digital assistant (PDA), peripheral (e.g. printer, etc.), any component of a computer, and/or any other type of logic. The architecture and/or functionality of the various previous figures and description may also be implemented in the form of a chip layout design, such as a semiconductor intellectual property (“IP”) core. Such an IP core may take any suitable form, including synthesizable RTL, Verilog, or VHDL, netlists, analog/digital logic files, GDS files, mask files, or a combination of one or more forms.

While this document contains many specific implementation details, these should not be construed as limitations on the scope of what may be claimed, but rather as descriptions of features that may be specific to particular implementations or embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination.

1. A portable computing device comprising:
a first digital image sensor facing out from a first side of the portable computing device;
a second digital image sensor facing out from a second side of the portable computing device; and
state change detection circuitry coupled to the first digital image sensor and the second digital image sensor, the state change detection circuitry designed to:
receive a first image from the first digital image sensor;
receive a second image from the second digital image sensor; and
change a state of the portable computing device if the first image is a blank image and the second image is not a blank image.

2. The portable computing device of claim 1, wherein the state change circuitry is designed to place the portable computing device in a sleep mode.

3. The portable computing device of claim 1, wherein the state change circuitry is designed to pause an application running on the portable computing device.

4. The portable computing device of claim 1, wherein the state change circuitry is designed to poll the first digital image sensor.

5. The portable computing device of claim 4, wherein the state change circuitry is designed to poll the first image sensor based on a signal generated from an ambient light sensor.

6. The portable computing device of claim 1, wherein the first side of the portable computing device is a front surface of the portable computing device.

7. The portable computing device of claim 1, wherein the first side of the portable computing device and the second side of the portable computing device are generally parallel to each other.

8. The portable computing device of claim 1, wherein the portable computing device comprises an operating system that allows for selection of the state change from one or more state change options.

9. The portable computing device of claim 1, wherein the portable computer device comprises a mobile telephone.

10. A method comprising:
receiving an input from a first image sensor;
determining if the input from the first image sensor is blank;
receiving an input from a second image sensor;
determining if the input from the second image sensor is blank; and
changing a state of a mobile computing device if the first input is blank and the second input is not blank.

11. The method of claim 10, wherein changing the state of the mobile computing device comprises placing a mobile phone into a sleep state.

12. The method of claim 10, wherein receiving the input from the second image sensor comprises receiving an image from a camera facing a back surface of the mobile computing device.

13. The method of claim 10, comprising polling the first image sensor if a polling condition is satisfied.

14. The method of claim 13, wherein the first image sensor is polled based on an input from an ambient light sensor.

15. The method of claim 13, wherein the polling condition is a signal from a gyroscope.

16. The method of claim 10, wherein receiving the input from the first image sensor comprises receiving an image from a CMOS sensor.

17. A non-transitory computer readable medium storing instructions that, when executed by the processing unit, causes the processing unit to perform operations comprising:
receiving an input from a first image sensor;
determining if the input from the first image sensor is blank;
receiving an input from a second image sensor;
determining if the input from the second image sensor is blank; and
changing a state of a mobile computing device if the first input is blank and the second input is not blank.

18. The non-transitory computer readable medium of claim 17, comprising instructions that, when executed by the processing unit, causes the processing unit to perform operations to poll the first image sensor if a polling condition occurs.

19. The non-transitory computer readable medium of claim 17 wherein changing the state comprises placing the processing unit into a sleep mode.

20. The non-transitory computer readable medium of claim 17 wherein receiving the first input comprises receiving an image from a digital camera facing the front surface of a mobile computing device.
